(19) United States
(12) Patent Application Publication
(10) Pub. No.: US 2023/0007738 A1
(43) Pub. Date: Jan. 5, 2023

(54) ELECTRIC HEATER FOR HEATING A SUBSTANCE IN A MOTOR VEHICLE

(71) Applicant: I.R.C.A. S.P.A. INDUSTRIA RESISTENZE CORAZZATE E AFFINI, Vittorio Veneto (IT)

(72) Inventors: Mario Eusebio, Pordenone (IT); Stefano Zanella, Montebelluna (IT); Federico Zoppas, Treviso (IT)

(21) Appl. No.: 17/756,621

(22) PCT Filed: Dec. 3, 2020
(86) PCT No.: PCT/IB2020/061446

§ 371 Date: May 27, 2022

(30) Foreign Application Priority Data
Dec. 3, 2019 (IT) 102019000022785

(51) Int. Cl. H05B 3/82; H05B 3/28; F24H 1/20

(52) U.S. Cl. CPC H05B 3/82; H05B 3/286; F24H 1/202; H05B 2203/02; H05B 2203/021; H05B 2203/013

(57) ABSTRACT

An electric heater for heating a substance, in particular for a tank for a system for reducing the environmental pollution of a motor vehicle;
the electric heater comprising
   a metal sheet adapted to generate heat when it is crossed by an electric current;
   two polymeric layers between which the metal sheet is arranged;
   at least one PTC layer, having a positive temperature coefficient, which at least partially coats the metal sheet;
wherein the two polymeric layers are hermetically sealed to each other, defining a casing which prevents the substance to be heated from coming into contact with the metal sheet;
wherein said at least one PTC layer has a thickness from 5 to 50 μm;
wherein said metal sheet is in contact, in particular directly in contact, with both the polymeric layers.

### CROSS-REFERENCE TO RELATED APPLICATIONS

This application claims priority to PCT International Application No. PCT/IB2020/061446 filed on Dec. 3, 2020, which application claims priority to Italian Patent Application No. 102019000022785 filed on Dec. 3, 2019, the disclosures of which are expressly incorporated herein by reference.

### STATEMENT RE: FEDERALLY SPONSORED RESEARCH/DEVELOPMENT

Not Applicable

### BACKGROUND

### Field of the Invention

The present invention relates to the field of electric heaters for heating a liquid or frozen substance in a motor vehicle, in particular for a system for reducing the environmental pollution of the motor vehicle.

The electric heater is particularly adapted to heat water or a solution of water and urea.

### Background Art

To heat a liquid or frozen substance in a motor vehicle, electric heaters may be used, provided with a heating element which generates heat by means of the Joule effect.

One of the main issues encountered in these applications is the adequate insulation between the heating element and the substance to be heated, which must not come into contact with each other.

Another issue concerns the control of the temperature of the heating element, which must not exceed the limits imposed by the features of the materials with which the electric heater is made, which may degrade when the heating element reaches a temperature which is too high.

The need is therefore felt for an electric heater whose heating element is adequately insulated from the substance to be heated, even when it is in the liquid state, and which may reach a maximum temperature compatible with the materials with which it is made.

### SUMMARY OF THE INVENTION

It is an object of the present invention to provide an electric heater whose heating element is adequately insulated from the substance to be heated, even when it is in the liquid state, and which may reach a maximum temperature compatible with the materials with which it is made.

In this context, it is another object of the present invention to provide an electric heater made of a material chemically compatible with the substance to be heated; in particular, which has an adequate chemical resistance with respect to the substance to be heated.

Furthermore, it is an object of the present invention to provide a thin electric heater which allows an effective and efficient heating of the substance and which may be easily produced at low cost.

The present invention achieves at least one of such objects, and other objects which will be apparent in the light of the present description, by means of an electric heater for heating a substance in a motor vehicle, in particular for a tank for a system for reducing the environmental pollution of a motor vehicle; the electric heater comprising
a metal sheet adapted to generate heat when it is crossed by an electric current;
two polymeric layers between which the metal sheet is arranged;
at least one PTC layer, electrically conductive and having a positive temperature coefficient, which at least partially coats the metal sheet;

wherein the two polymeric layers are hermetically sealed to each other, defining a casing which prevents the substance to be heated from coming into contact with the metal sheet;

wherein the metal sheet is in contact, in particular directly in contact, with both of said polymeric layers;

wherein said at least one PTC layer preferably has a thickness from 5 to 50 μm.

Advantageously, such a thin thickness allows to optimally produce an electric heater wherein the metal sheet is in contact, in particular directly in contact, with both of said polymeric layers.

Advantageously, thereby, the heating effect of the electric heater is optimized.

It is particularly preferable that said at least one PTC layer is formed by or consists of an electrically conductive ink. An electrically conductive ink allows to optimally produce a particularly thin PTC layer, in particular having the aforesaid thickness.

Advantageously, it is not necessary, and preferably it is not provided, a further metal sheet which extends on a distinct plane, in particular distinct and parallel, with respect to the plane in which said metal sheet of the electric heater extends. Indeed, as already said, the metal sheet of a heater in accordance with the invention can advantageously come into contact with both of the polymeric layers.

Preferably, said thickness of said at least one PTC layer is from 30 to 50 μm.

The invention also relates to a tank, or a device adapted to receive a liquid, according to claim 16.

Advantageously, the polymeric layers sealed to each other prevent the substance to be heated from coming into contact with the metal sheet, even when the substance is in the liquid state.

It is also advantageous that at least one layer or element is provided with Positive Temperature Coefficient (PTC), i.e., the resistivity of which increases with the increase of the temperature.

The PTC layer allows to substantially obtain a self-regulation of the temperature of the metal sheet, and therefore unwanted overheating of the polymeric layers is avoided. Therefore, the range of usable polymeric materials may be expanded.

It is however preferable, as it is particularly advantageous, to make the polymeric layers in a material comprising or consisting of polypropylene. In other words, the polymeric layers are preferably made of polypropylene.

Polypropylene has been carefully selected as it is chemically compatible with aqueous solutions of water and urea, such as, for example, AdBlue®, which is very often used in motor vehicles to reduce the environmental pollution thereof. Furthermore, polypropylene can be heated up to relatively high temperatures.

In the present description, “substance” means, in particular, a liquid which may be subject to freezing and thawing.

Further features and advantages of the invention will become more apparent in light of the detailed description of non-exclusive example embodiments.

The dependent claims describe particular embodiments of the invention.

### BRIEF DESCRIPTION OF THE FIGURES

In the description of the invention, reference is made to the accompanying drawings, which are provided by way of non-limiting example, in which:

FIG. 1 diagrammatically shows a section of an electric heater according to the invention;

FIG. 2 diagrammatically shows a tank provided with an electric heater according to the invention;

FIG. 3 diagrammatically shows a top plan view of an electric heater in accordance with the invention, in which a component is not shown for illustrative purposes;

FIG. 4 diagrammatically shows the section A-A of FIG. 3;

FIG. 5 diagrammatically shows the section B-B of FIG. 3.

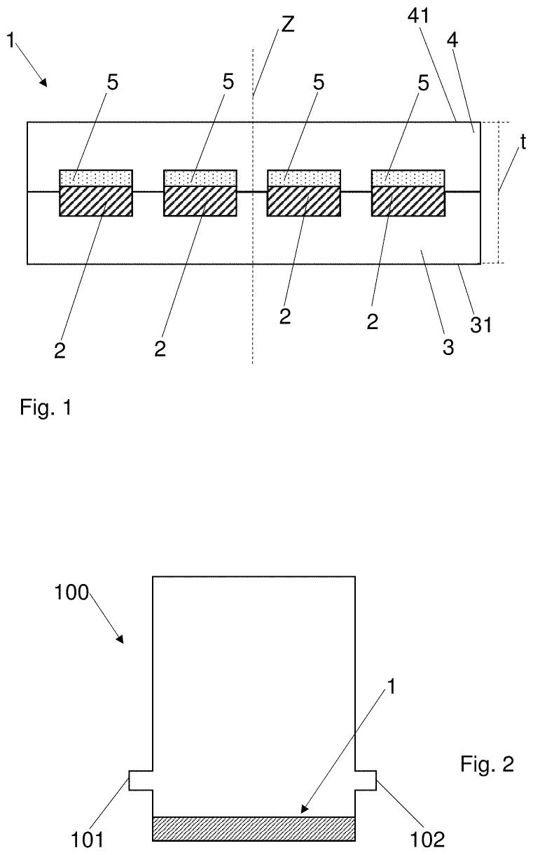

The same elements or components have the same reference numerals.

### DESCRIPTION OF EMBODIMENTS OF THE INVENTION

With reference to the Figures, exemplary embodiments of an electric heater 1 according to the invention and of a tank 100 comprising an electric heater 1 therein are described.

The electric heater 1 and the tank 100 are used, in particular, for heating a substance contained in a tank 100 of a motor vehicle (such as for example a car, van or truck), in particular, a substance for reducing the environmental pollution of a motor vehicle. The substance is, for example, a solution of water and urea, preferably comprising at least 30% urea, such as, for example, the solution known by the trade name AdBlue®. The electric heater 1 is also adapted to be arranged in a tank 100 containing a substance for cleaning parts of the motor vehicle, for example, the windshield, the headlights or one or more sensors.

The electric heater 1 comprises
a metal sheet 2, or heating sheet, adapted to be connected to a source of electricity to generate heat when it is crossed by an electrical current;
two polymeric layers 3, 4 between which the metal sheet 2 is arranged;
at least one PTC layer 5, i.e., one or more PTC layers 5, electrically conductive and having a positive temperature coefficient, which, at least partially, preferably partially, in particular only partially, coats the metal sheet 2;

wherein the two polymeric layers 3, 4 are hermetically sealed to each other, defining a casing which prevents the substance to be heated from coming into contact with the metal sheet 2.

The metal sheet 2, the two polymeric layers 3, 4 and said at least one PTC layer 5 substantially define a sandwich structure. The metal sheet 2 and said at least one PTC layer 5 are enclosed in the two polymeric layers 3, 4.

By way of example and not by way of limitation, an electric heater in accordance with the invention defines a set of three axes X, Y, Z perpendicular to each other.

Each polymeric layer 3, 4 has a respective surface or external face 31, 41. Preferably, the external face 31 is parallel or substantially parallel to the external face 41.

The external face 31 is one of the two faces, or surfaces, opposite to each other, having the greatest extension of the polymeric layer 3,

The external face 41 is one of the two faces, or surfaces, opposite to each other, having the greatest extension of the polymeric layer 4.

Preferably, the external faces 31, 41 are flat or substantially flat.

The external faces 31, 41 preferably extend parallel to the plane X-Y.

Preferably, the metal sheet 2 is arranged between two planes, in particular, only between two planes. In particular, said two planes are parallel to the external faces 31, 41, preferably parallel to the plane X-Y.

Preferably, the electric heater 1 has an overall thickness t from 0.5 to 4 mm or from 0.2 to 1 mm, preferably from 0.5 to 1 mm; said overall thickness t being smaller than the width and the length of the electric heater 1.

Said overall thickness is measured parallel to the axis Z, i.e., preferably perpendicular to the external faces 31, 41.

The overall thickness of the electric heater 1 preferably corresponds to the overall thickness of said sandwich structure.

The thickness t is defined, in particular, by the distance between the external faces 31, 41, opposite to each other, of the two polymeric layers 3, 4. The electric heater 1 is therefore advantageously very thin.

The metal sheet 2, in particular, defines a heating track or path. By way of example and not by way of limitation, the track may comprise one or more serpentine portions or may have another geometry.

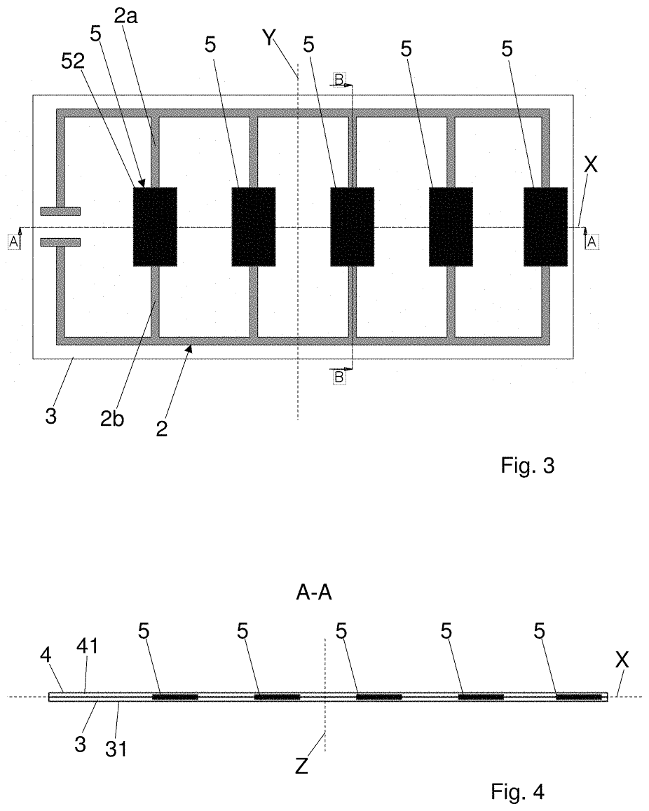

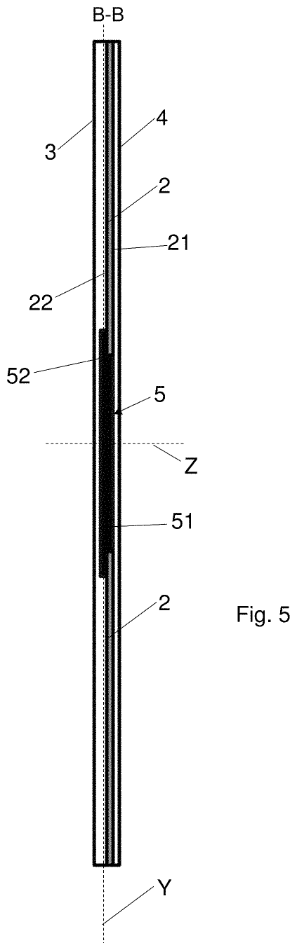

Preferably, at least a stretch of the heating track is defined by a PTC layer 5 (as shown, in particular, in FIGS. 3 and 5).

Preferably, at least two portions or stretches 2a, 2b of the metal sheet 2 are joined or connected to each other by a PTC layer 5. In other words, said at least two stretches 2a, 2b of the metal sheet 2 are electrically in contact with each other, in particular they are electrically connected in parallel, by means of said PTC layer 5, preferably only by means of said PTC layer 5. An adequate electrical contact between the two stretches 2a, 2b is ensured by the fact that part of the PTC layer 5 coats (i.e., covers) the metal sheet 2. In particular, the PTC layer 5 coats both the stretch 2a (for example, a part thereof) and the stretch 2b (for example, a part thereof).

More in detail, preferably, the PTC layer 5 comprises a portion 51 (FIG. 5) arranged between the two planes between which the metal sheet 2 is arranged, preferably only between said two planes. The portion 51 preferably fills all the space between the two stretches 2a, 2b.

The PTC layer 5 also comprises a portion 52 which extends, for example, above one of the two planes between which the metal sheet 2 is arranged. The portion 52 coats the metal sheet 2.

Preferably, said portion 52 has a width, for example parallel to the axis X, which is greater with respect to the width of each of the stretches 2a, 2b joined together by the PTC layer 5.

In all the embodiments, a plurality of PTC layers 5 may be provided, which are preferably distinct, in particular, separate, from each other. In FIG. 3, for example, five PTC layers 5 are provided, although a different number of PTC layers may be provided.

It is clear that in this description, when one or more features related to a PTC layer 5 are described, said one or more features also refer to the other PTC layers 5.

Preferably, when more than one PTC layer 5 is provided, pairs of portions or stretches of metal sheet 2 are joined to each other by a respective PTC layer 5, as described for the stretches 2a, 2b.

Preferably, in all the embodiments, only one electrical conductor is provided, adapted to generate heat when it is crossed by an electric current. Said single electrical conductor comprises or consists of the metal sheet 2 and the one or more PTC layers 5.

Preferably, it is provided one metal sheet 2, in particular, only one metal sheet 2.

Optionally, the metal sheet 2 may be formed by two or more parts, for example by two parts, which are joined to each other, in particular, they are electrically connected to each other, by means of one or more PTC layers 5. More in detail, said two or more parts are electrically connected in parallel with each other.

Advantageously, it is not necessary, and preferably it is not provided, a further metal sheet which extends on a distinct plane, in particular, distinct and parallel, with respect to the plane in which said metal sheet 2 of the electric heater extends.

The metal sheet 2 preferably has a thickness, in particular parallel to the axis Z, from 9 to 100 μm, preferably from 9 to 60 μm.

The metal sheet 2 is preferably made of a material comprising or consisting of copper, aluminum, for example, aluminum alloy, or steel.

Advantageously, as already mentioned, at least one surface of the metal sheet 2 is coated with at least one electrically conductive layer having a positive temperature coefficient, also called Positive Temperature Coefficient (PTC) layer or element, indicated with reference numeral 5.

For example, one of the two surfaces 21, 22, or faces, opposite to each other, of the metal sheet 2 is provided with the PTC layer 5, although it may be provided that both surfaces 21, 22, opposite to each other, of the metal sheet 2 are provided with a PTC layer 5, in particular, of a respective PTC layer or, in other words, of a respective portion of the same PTC layer 5.

The PTC layer 5 may be formed by or consist of, for example, a conductive ink. The conductive ink is, for example, deposited on the metal sheet 2, preferably by means of screen printing. Said at least one PTC layer 5 preferably and advantageously has a thickness of from 5 to 50 μm (micrometers), for example, from 30 to 50 μm. Said thickness being, in particular, measured parallel to the axis Z.

When a plurality of PTC layers 5 is provided, each PTC layer preferably and advantageously has the aforesaid thickness from 5 to 50 μm, for example, from 30 to 50 μm.

Said thickness is, in particular, the overall thickness of each PTC layer 5.

The PTC layer 5 is preferably in direct contact with the metal sheet, or heating sheet 2.

Optionally, 50% to 90% of the surface, in particular of the total surface, of the metal sheet is coated with one or more PTC layers 5.

The resistivity of each PTC layer 5 increases with the increase of temperature, and therefore allows for a temperature regulation of the metal sheet 2, so that performance safety may be ensured and unwanted overheating is avoided. In particular, it is avoided that the polymeric layers 3, 4 reach temperatures which are too high. For example, the electric heater 1, in particular the metal sheet 2 and the PTC layer 5, may be configured to reach a maximum temperature from 40 to 100° C.

The polymeric layers 3, 4 are advantageously hermetically fixed to each other at least at the edge or edge portion thereof. In particular, the edge portion, in particular the entire edge portion, of the polymeric layer 3 is fixed to the edge portion, in particular to the entire edge portion, of the polymeric layer 4.

The polymeric layers 3, 4 may be fixed to each other, for example, by welding.

Each polymeric layer 3, 4 is preferably a sheet, in particular, a flexible sheet, preferably flat or substantially flat.

Preferably, each polymeric layer 3, 4 has a thickness of from 0.1 to 2 mm.

One or both of the polymeric layers 3, 4 are adapted to come into contact, in particular, directly into contact, with the substance to be heated.

Preferably, the two polymeric layers 3, 4 are made of a material comprising or consisting of polypropylene.

Polypropylene is particularly advantageous as it is chemically compatible with solutions of water and urea, in particular comprising at least 30% urea. In other words, polypropylene has a high resistance to degradation caused by the solution of water and urea.

Alternatively, in all the embodiments, the two polymeric layers 3, 4 may be made of a material comprising or consisting of PET (Polyethylene terephthalate), silicone, Polyimide (for example, Kapton), or PEN (Polyethylene naphthalate). In other words, the two polymeric layers 3, 4 may be made of PET, silicone, Polyimide (for example, Kapton), or PEN.

Preferably, in all the embodiments, the metal sheet 2 is in contact, in particular directly in contact, with one or both of said two polymeric layers 3, 4, preferably, with both of said two polymeric layers 3, 4.

Preferably, said at least one PTC layer 5 is in contact, in particular, directly in contact with one of the two polymeric layers 3, 4, or with both polymeric layers 3, 4, preferably with both polymeric layers 3, 4.

In particular, preferably, a first face 21 (FIG. 5) of the metal sheet 2 is in contact with a polymeric layer 4, and a second face 22, opposite to said first face 21, of the metal sheet 2 (i.e., of the same metal sheet 2) is in contact with the other polymeric layer 3. More in detail, the first face 21 of the metal sheet 2 is in contact with the internal face or surface of the polymeric layer 4, said internal face being opposite to the external face 41. The internal face and the external face 41 are, as already mentioned, the two faces of greatest extension, in particular surface extension, of the polymeric layer 4.

The second face 22 of the metal sheet 2 is in contact with the internal face or surface of the polymeric layer 3, said internal face being opposite to the external face 31. The internal face and the external face 31 are, as already mentioned, the two faces of greatest extension, in particular surface extension, of the polymeric layer 3.

Preferably, said at least one PTC layer 5 is in contact with both polymeric layers 3, 4, as it may be seen, for example, in FIG. 5.

In particular, said at least one PTC layer 5 is in contact with the same faces or surfaces of the polymeric layers 3, 4 with which the metal sheet 2 is in contact.

In other words, said at least one PTC layer 5 is in contact with said internal face of the polymeric layer 3 and with said internal face of the polymeric layer 4.

Preferably, in all the embodiments, in some areas of the electric heater, between the two polymeric layers 3, 4 only the metal sheet 2 is interposed.

Preferably, and advantageously, in all the embodiments, where only the metal sheet 2 is provided (in other words, in the areas in which only the metal sheet 2 is present between the polymeric layers 3, 4), the distance, in particular parallel to the axis Z, between the internal faces of the polymeric layers 3, 4, is equal to or substantially equal to the thickness of the metal sheet 2, preferably from 9 to 100 μm.

FIG. 2 diagrammatically shows a tank 100 provided with an electric heater 1.

The tank 100 is preferably provided with an inlet 101 and an outlet 102 for the substance, in particular when it is in the liquid state.

The electric heater 1 is preferably fixed to a wall, for example, a bottom wall, of the tank 100. Alternatively, the electric heater 1 may be arranged in the tank 100, so that it may be substantially completely immersed in the substance to be heated, whereby both polymeric layers 3, 4 are adapted to come into contact with the substance contained in the tank 100.

The tank 100 may have, for example, a capacity from 0.5 to 30 liters, for example, from 0.5 to 5 liters or from 12 to 24 liters.

1-16. (canceled)

17. An electric heater for heating a substance contained in a tank of a motor vehicle;
the electric heater comprising
a metal sheet adapted to generate heat when it is crossed by an electric current;
two polymeric layers between which the metal sheet is arranged;
at least one PTC layer, electrically conductive and having a positive temperature coefficient, which at least partially coats the metal sheet;
wherein said at least one PTC layer is formed by an electrically conductive ink;
wherein the two polymeric layers are made of polypropylene;
wherein the two polymeric layers made of polypropylene are hermetically sealed to each other, defining a casing which prevents the substance to be heated from coming into contact with the metal sheet;
wherein said at least one PTC layer has a thickness from 5 to 50 μm;
and wherein said metal sheet is in contact with both of said polymeric layers made of polypropylene.

18. The electric heater according to claim 17, wherein said electrically conductive ink is deposited on the metal sheet.

19. The electric heater according to claim 17, wherein said at least one PTC layer is in contact with both of said two polymeric layers.

20. The electric heater according to claim 19, wherein said at least one PTC layer is in contact with the same faces of the polymeric layers with which the metal sheet is in contact.

21. The electric heater according to claim 17, wherein from 50% to 90% of the outer surface of the metal sheet is coated with said at least one PTC layer.

22. The electric heater according to claim 17, wherein the two faces opposite to each other of the metal sheet are coated with a respective PTC layer or wherein only one of the two faces opposite to each other is coated with a PTC layer.

23. The electric heater according to claim 17, wherein each polymeric layer has a thickness from 0.1 to 2 mm.

24. The electric heater according to claim 17, wherein the metal sheet, the two polymeric layers and said at least one PTC layer define a sandwich structure; and wherein the electric heater has an overall thickness from 0.5 to 4 mm; said overall thickness being smaller than the width and the length of the electric heater.

25. The electric heater according to claim 17, wherein the metal sheet defines a heating track, and wherein at least one stretch of the heating track is defined by said at least one PTC layer.

26. The electric heater according to claim 17, wherein said at least one PTC layer comprises a portion arranged between two planes between which the metal sheet is arranged.

27. The electric heater according to claim 17, comprising a plurality of PTC layers.

28. The electric heater according to claim 17, wherein in some areas of the electric heater, between the two polymeric layers only the metal sheet is interposed, and wherein in said some areas in which only the metal sheet is present between the polymeric layers, the distance between the internal faces of the polymeric layers is equal to or substantially equal to the thickness of the metal sheet.

29. The electric heater according to claim 17, wherein the meal sheet has a thickness from 9 to 100 μm.

30. A tank of a motor vehicle, the tank comprising at least one electric heater therein according to claim 17.
